(19) United States
(12) Patent Application Publication
(10) Pub. No.: US 2014/0003662 A1
(43) Pub. Date: Jan. 2, 2014

(54) REDUCED IMAGE QUALITY FOR VIDEO DATA BACKGROUND REGIONS

(71) Applicants: Peng Wang, Beijing (CN); Yimin Zhang, Beijing (CN); Qiang Eric Li, Beijing (CN); Jianguo Li, Beijing (CN); Lin Xu, Beijing (CN)

(72) Inventors: Peng Wang, Beijing (CN); Yimin Zhang, Beijing (CN); Qiang Eric Li, Beijing (CN); Jianguo Li, Beijing (CN); Lin Xu, Beijing (CN)

(21) Appl. No.: 13/977,469

(22) PCT Filed: Dec. 16, 2011
(86) PCT No.: PCT/CN11/84118

§ 371 Date: Sep. 17, 2013

(51) Int. Cl. G06K 9/00

(52) U.S. Cl. CPC G06K 9/00268
USPC 382/103; 382/195

(57) ABSTRACT

Systems, apparatus, articles, and methods are described including operations to detect a face based at least in part on video data. A region of interest and a background region may be determined based at least in part on the detected face. The background region may be modified to have a reduced image quality.

### BACKGROUND

Videotelephony typically refers to technologies utilized for the reception and transmission of video and associated audio data by users at different locations, for communication between these users in real-time. In some implementations, videotelephony may be designed for consumers in remote and/or mobile locations, and may be referred to as consumer video chat in such implementations. For example, such consumer video chat technologies may, in some instances, be implemented via television, tablet computer, laptop computer, desktop computer, mobile phone, or the like.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video chat system;

FIG. 2 is a flow chart illustrating an example background modification process;

FIG. 3 is an illustrative diagram of an example video chat system in operation;

FIG. 4 illustrates several example images processed to have background modification;

FIG. 5 is an illustrative diagram of an example system; and

FIG. 6 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Consumer video chat applications may place increasing demands bandwidth associated with various technologies, such as television, tablet computer, laptop computer, desktop computer, mobile phone, or the like. Some implementations discussed below addresses such bandwidth demands by doing smart bit allocation while preserving reasonable user experience and saving bandwidth. During video chat, users often may care more about the foreground human and pay less attention to the background surroundings. That means the focus of attention is on talking people. For example, the human eye operates in a similar manner to the focus of field concept in digital camera, where the item focused on is typically in clear focus, while items in the foreground and/or background may be blurry or of lower quality. As will be described below, a background portion of video data may be pre-blurred so as to simulate focus of field concept while keeping facial features in clear focus. For example, a face-aware blur modeling and multi-level blending approach may be utilized as a pre-encoding operation.

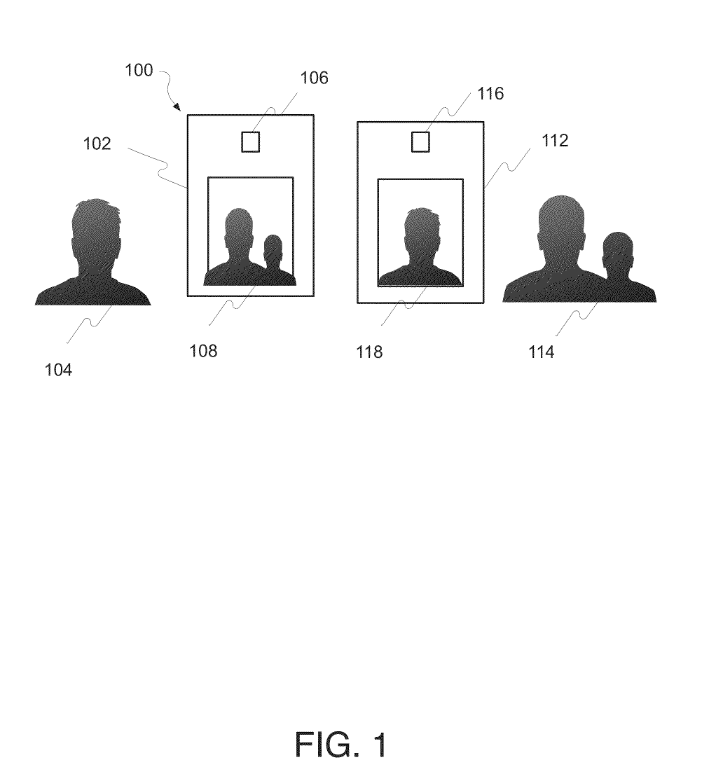

FIG. 1 is an illustrative diagram of an example video chat system 100, arranged in accordance with at least some implementations of the present disclosure. In the illustrated implementation, video chat system 100 may include a first device 102 associated with a first user 104. First device 102 may include an imaging device 106 and a display 108. Imaging device 106 may be configured to capture video data from first user 104.

In some examples, first device 102 may include additional items that have not been shown in FIG. 1 for the sake of clarity. For example, first device 102 may include a processor, an radio frequency-type (RF) transceiver, and/or an antenna. Further, first device 102 may include additional items such as a microphone, a speaker, an accelerometer, memory, a router, network interface logic, etc. that have not been shown in FIG. 1 for the sake of clarity.

Similarly, a second device 112 may be associated with a second user 114. Second device 112 may be identical to first device 102 or may be a different type of device. Second device 112 may include an imaging device 116 and a display 118. Imaging device 116 may be configured to capture video data from first user 104.

First device 102 may capture video data of first user 104 via imaging device 106. Such video data of first user 104 may be communicated to second device 112 and presented via display 118 of second device 112. Similarly, second device 112 may capture video data of second user 114 via imaging device 116. Such video data of second user 114 may be communicated to first device 102 and presented via display 108 of first device 102.

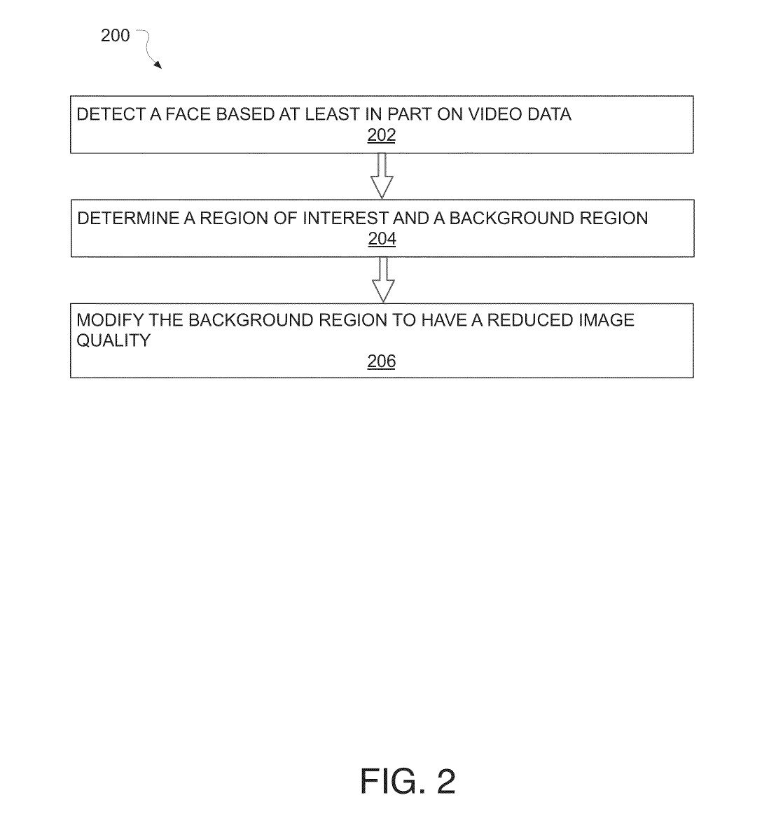

As will be discussed in greater detail below, first device 102 and/or second device 112 may be used to perform some or all of the various functions discussed below in connection with FIGS. 2 and/or 3. For example, first device 102 may include a background modification module (not shown) that may be configured to undertake any of the operations of FIG. 2 and/or 3, as will be discussed in further detail below. For example, prior to communicating the video data of first user 104, the video data may be modified. For example, the background modification module may modify a background region of the video data to have a reduced image quality.

In operation, first device 102 and/or second device 112 may utilize a smart bit allocation approach to preserve reasonable good user experience while also reducing bandwidth usage and/or replacing the background for privacy concerns. When users are in use of video chat, their major attention typically may be on foreground talking people. The irrelevant background scenes are less a focus of direct eye contact. Accordingly, a foreground human may be set on focus while a background scene may be blurred out of focus. From a viewer's perspective, such out of focus background scene appear blurry if viewed directly; however, appear normal when that viewer's direct eye contact is on the in focus foreground human.

FIG. 2 is a flow chart illustrating an example background modification process 200, arranged in accordance with at least some implementations of the present disclosure. In the illustrated implementation, process 200 may include one or more operations, functions or actions as illustrated by one or more of blocks 202, 204, and/or 206. By way of non limiting example, process 200 will be described herein with reference to example video chat system 100 of FIG. 1.

As discussed above, video data of the first user may be captured via the imaging device. Such video data of the first user may be communicated to the second device. Prior to communicating the video data of the first user, the video data may be modified. For example, the background modification module may modify a background region of the video data to have a reduced image quality. In some examples, process 200 may determine the background region based at least in part on facial detection.

As will be described in greater detail below, the operations of FIG. 2 may be performed as a pre-encoding operation (e.g., before video encoding and transcoding) in consumer video chat. For example, such operation may include face detection and/or tracking), background blurring, and/or background blending. In a typical video chat, there are three parties involved: front-end, network, and back-end. Here, the operations of FIG. 2 may focus primarily on front-end operation (e.g., the operations of FIG. 2 may occur in between live video data capture and video encoding). As the operations of FIG. 2. may focus primarily on front-end operation, such an approach may be independent of audio-visual coding schemes, which may make it scalable to different devices and bandwidth channels.

Process 200 may begin at block 202, “DETECT A FACE BASED AT LEAST IN PART ON VIDEO DATA”, where a face of a user may be detected. For example, the face of the user may be detected based at least in part on video data.

In some examples, the detection of the face may include detecting the face based at least in part on a Viola-Jones-type framework (see, e.g., Paul Viola, Michael Jones, Rapid Object Detection using a Boosted Cascade of Simple Features, CVPR 2001 and/or PCT/CN2010/000997, by Yangzhou Du, Qiang Li, entitled TECHNIQUES FOR FACE DETECTION AND TRACKING, filed Dec. 10, 2010). Such facial detection techniques may allow relative accumulations to include face detection, landmark detection, face alignment, smile/blink/gender/age detection, face recognition, detecting two or more faces, and/or the like.

In some examples, video data of the first user may be captured via a webcam sensor or the like (e.g., a complementary metal-oxide-semiconductor-type image sensor (CMOS) or a charge-coupled device-type image sensor (CCD)), without the use of a red-green-blue (RGB) depth camera and/or microphone-array to locate who is speaking In other examples, an RGB-Depth camera and/or microphone-array might be used in addition to or in the alternative to the webcam sensor.

Processing may continue from operation 202 to operation 204, “DETERMINE A REGION OF INTEREST AND A BACKGROUND REGION”, where a region of interest and a background region may be determined. For example, the region of interest and the background region may be determined based at least in part on the detected face.

As used herein, the term “background” may refer to an area of a video image not defined as a region of interest, and may include image portions located behind or in front (e.g., foreground) of a determined region of interest.

Processing may continue from operation 204 to operation 206, “MODIFY THE BACKGROUND REGION TO HAVE A REDUCED IMAGE QUALITY”, where the background region may be modified. For example, the background region may be modified to have a reduced image quality.

In some examples, the reducing of the image quality associated with the background region may include applying a blurring effect to the background region. For example such a blurring effect may be based at least in part on a Point Spread Function and noise model, or the like.

Unintentional blurry images may be usually caused by camera shake or object's fast movement. It may be difficult to obtain sharp images by simply denoising the noisy image or deblurring the blurry image alone. Image deblurring typically estimates the parametric forms of noise or motion path during camera shake. Different from the challenges in deblurring, intentional background blurring may be implemented as a generation procedure. In some examples, intentional background blurring may be achieved by specifying the Point Spread Function and noise model. In computer graphics, vision-realistic rendering may be utilized to simulate depth of field effects (e.g., foreground and background blurring). In some examples, a simple blur algorithm may be used to generate an out-of-focus effect for an entire image.

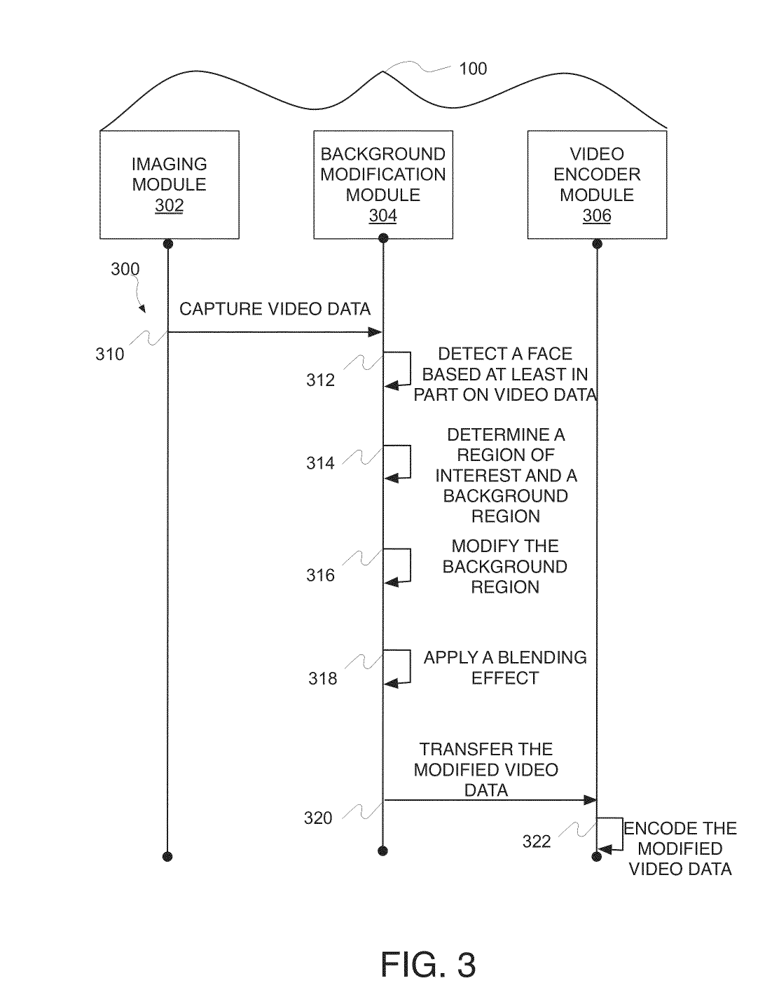

Some additional and/or alternative details related to process 200 may be illustrated in one or more examples of implementations discussed in greater detail below with regard to FIG. 3.

FIG. 3 is an illustrative diagram of an example video chat system 100 and background modification process 300 in operation, arranged in accordance with at least some implementations of the present disclosure. In the illustrated implementation, process 300 may include one or more operations, functions or actions as illustrated by one or more of actions 310, 312, 314, 316, 318, 320, and/or 322. By way of non-limiting example, process 200 will be described herein with reference to example video chat system 100 of FIG. 1.

In the illustrated implementation, video chat system 100 may include an imaging module 302, a background modification module 304, a video encoder module, the like, and/or combinations thereof. As illustrated, imaging module 302 may be capable of communication with background modification module 304, and background modification module 304 may be capable of communication with video encoder module 306. Although video chat system 100, as shown in FIG. 3, may include one particular set of blocks or actions associated with particular modules, these blocks or actions may be associated with different modules than the particular module illustrated here.

Process 300 may begin at block 310, “CAPTURE VIDEO DATA”, where video data may be captured. For example, video data of the first user may be captured via imaging module 302. Such video data of the first user may be communicated to background modification module 304. In some examples, capturing the video data may occur in real-time.

Processing may continue from operation 310 to operation 312, “DETECT A FACE BASED AT LEAST IN PART ON VIDEO DATA”, where a face of a user may be detected. For example, the face of the user may be detected, via background modification module 304, based at least in part on video data.

Processing may continue from operation 312 to operation 314, “DETERMINE A REGION OF INTEREST AND A BACKGROUND REGION”, where a region of interest and a background region may be determined. For example, the region of interest and the background region may be determined, via background modification module 304, based at least in part on the detected face.

Processing may continue from operation 314 to operation 316, “MODIFY THE BACKGROUND REGION”, where the background region may be modified. For example, the background region may be modified, via background modification module 304, to have a reduced image quality.

Processing may continue from operation 316 to operation 318, “APPLY A BLENDING EFFECT”, where a blending effect may be applied. For example, a blending effect may be applied, via background modification module 304, to a transition area In some examples, the transition area may be located at a border between the region of interest and the background region.

In operation, the blending effect may generate a smooth transition from an “out of focus” background region to an “on focus” region of interest and avoid unpleasant artifacts. In some examples, different from dealing with still image, video data images may need to consider spatial-temporal consistency and provide a natural and smooth user experience. In order to provide a natural and smooth user experience, a blending effect may be applied to a transition area located at a border between the in focus region of interest and the out of focus background region. In some examples, such a blending effect may include an alpha-type blending effect (see, e.g., Alexei Efros, Computational Photography—Image Blending, CMU, Spring 2010), a feathering-type blending effect (e.g., simple averaging, center seam, blurred seam, center weighting, the like, and/or combinations thereof), a pyramid-type blending effect, the like, and/or combinations thereof. One issue in blending is to choose the optimal window for avoiding seams and ghosting. In one example, a simple averaging-type alpha blending approach may be used to composite the “on focus” region of interest with the “out of focus” background region.

Processing may continue from operation 318 to operation 320, “TRANSFER THE MODIFIED VIDEO DATA”, where the modified video data may be transferred. For example, the modified video data may be transferred from background modification. module 304 to video encoder module 306.

Processing may continue from operation 320 to operation 322, “ENCODE THE MODIFIED VIDEO DATA” where the modified video data may be encoded. For example, the modified video data may be encoded, via video encoder module 306. In this example, the encoding may occur after modifying the background region and applying the blending effect.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

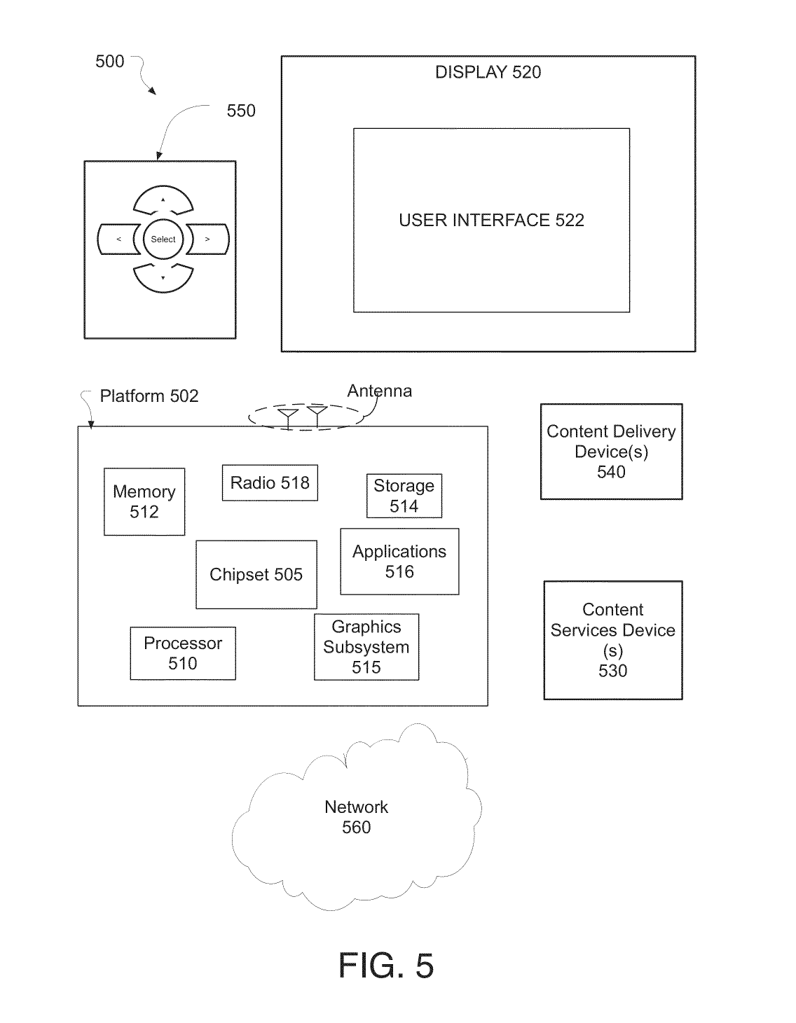

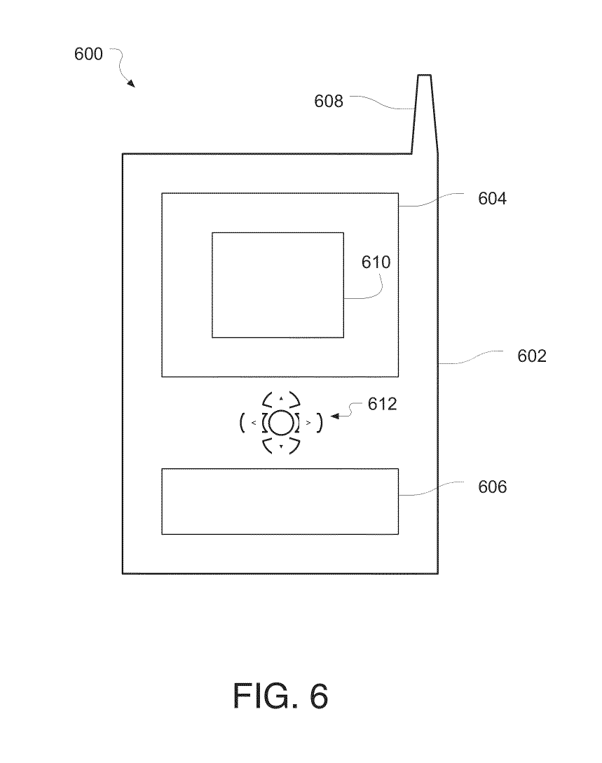

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

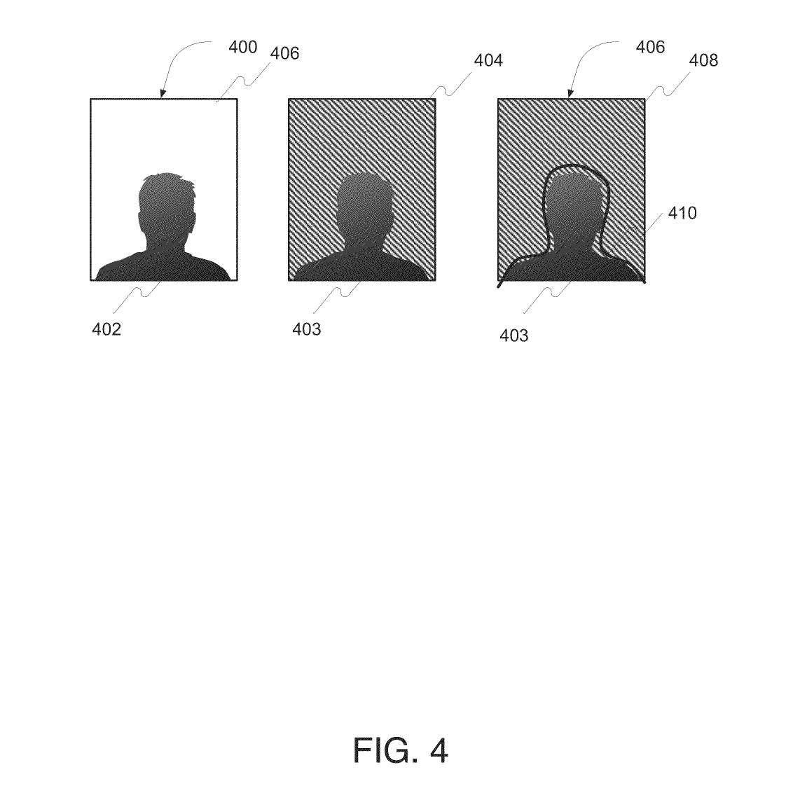

FIG. 4 illustrates several example images processed to have background modification, arranged in accordance with at least some implementations of the present disclosure. In the illustrated implementation, unmodified video data image 400 may be processed so that a face 402 of the user may be detected. A region of interest 403 may be determined based at least in part on detected face 402. Similarly, background region 404 may be determined based at least in part on detected face 402.

A modified video data image 406 may be processed so that modified background region 408 may have a reduced image quality. Additionally, modified video data image 406 may be processed so that a blending effect 410 may be applied. For example, blending effect 410 may be applied to a transition area located at a border between region of interest 403 and the modified background region 408.

In operation, preliminary experiments have shown up to a fifty-five percent saving of bandwidth on average independent to video encoding/decoding schemes. For example, example 640 bye 480 motion pictures may normally have a 5.93 MB size video, with the approach of FIG. 2 or 3; the video may have a size of 2.68 MB. The bandwidth saving is up to a fifty-five percent saving, in this example the video stream was compressed in XVID (e.g., a video codec library following the MPEG-4 standard) format.

FIG. 5 illustrates an example system 500 in accordance with the present disclosure. In various implementations, system 500 may he a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interact device (MID), messaging device, data communication device, and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 510 may be dual-core processor(s), dual-core mobile processor(s), and so forth,

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VRU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (hut are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off” in addition, chipset 505 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (MC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct anode to process the media information in a predetermined manner. The embodiments, however, are not limited to the elements or in the context shown or described in FIG. 5.

As described above, system 500 may be embodied in varying physical styles or form factors. FIG. 6 illustrates implementations of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may he implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may he implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. A computer-implemented method, comprising:
detecting a face based at least in part on video data;
determining a region of interest and a background region based at least in part on the detected face; and
modifying the background region to have a reduced image quality.

2. The method of claim 1, further comprising capturincapturing the video data in real-time.

3. The method of claim 1, wherein the detection of the face comprises detecting two or more faces.

4. The method of claim 1, wherein the detection of the face comprises detecting the face based at least in part on a Viola-Jones-type framework.

5. The method of claim 1, wherein the reducing of the image quality associated with the background region comprises applying a blurring effect to the background region.

6. The method of claim 1, wherein the reducing of the image quality associated with the background region comprises applying a blurring effect to the background region based at least in part on a Point Spread Function and noise model.

7. The method of claim 1, further comprising applying a blending effect to a transition area, wherein the transition area is located at a border between the region of interest and the background region.

8. The method of claim 1, further comprising applying a blending effect to a transition area, wherein the transition area is located at a border between the region of interest and the background region, and wherein the blending effect comprises an alpha-type blending effect, feathering-type blending effect, and/or a pyramid-type blending effect.

9. The method of claim 1, further comprising encoding the video data including the modified background region, wherein the encoding occurs after modifying the background region.

10. The method of claim 1, further comprising:
capturing the video data in real-time;
applying a blending effect to a transition area, wherein the transition area is located at a border between the region of interest and the background region, and wherein the blending effect comprises an alpha-type blending effect, a feathering-type blending effect, and/or a pyramid-type blending effect; and
encoding the video data including the modified background region, wherein the encoding occurs after modifying the background region and applying the blending effect.

11. The method of claim 1, further comprising:
capturing the video data in real-time;
applying a blending effect to a transition area, wherein the transition area is located at a border between the region of interest and the background region, and wherein the blending effect comprises an alpha-type blending effect, a feathering-type blending effect, and/or a pyramid-type blending effect; and
encoding the video data including the modified background region, wherein the encoding occurs after modifying the background region and applying the blending effect,
wherein the detection of the face comprises detecting two or more faces.
wherein the detection of the face comprises detecting the face based at least in part on a Viola-Jones-type framework,
wherein the reducing of the image quality associated with the background region comprises applying a blurring effect to the background region based at least in part on a Point Spread Function and noise model.

12. An article comprising a computer program product having stored therein instructions that, if executed, result in:
detecting a face based at least in part on video data;
determining a region of interest and a background region based at least in part on the detected face; and
modifying the background region to have a reduced image quality.

13. The article of claim 12, wherein the instructions, if executed, further result in capturing the video data in real-time.

14. The article of claim 12, wherein the detection of the face comprises detecting two or more faces.

15. The article of claim 12, wherein the reducing of the image quality associated with the background region comprises applying a blurring effect to the background region based at least in part on a Point Spread Function and noise model.

16. The article of claim 12, wherein the instructions, if executed, further result in applying a blending effect to a transition area, wherein the transition area is located at a border between the region of interest and the background region, and wherein the blending effect comprises an alpha-type blending effect, a feathering-type blending effect, and/or a pyramid-type blending effect,

17. The article of claim 12, wherein the instructions, if executed, further result in encoding the video data including the modified background region, wherein the encoding occurs after modifying the background region.

18. An apparatus, comprising:
a processor configured to:
detect a face based at least in part on video data;
determine a region of interest and a background region based at least in part on the detected face; and
modify the background region to have a reduced image quality.

19. The apparatus of claim 18, wherein the processor is further configured to capture the video data in real-time.

20. The apparatus of claim 18, wherein the detection of the face comprises detection of two or more faces.

21. The apparatus of claim 18, wherein the reduction of the image quality associated with the background region comprises application of a blurring effect to the background region.

22. The apparatus of claim 18, wherein the reduction of the image quality associated with the background region comprises application of a blurring effect to the background region based at least in part on a Point Spread Function and noise model.

23. The apparatus of claim 18, wherein the processor is further configured to apply a blending effect to a transition area, wherein the transition area is located at a border between the region of interest and the background region, and wherein the blending effect comprises an alpha-type blending effect, a feathering-type blending effect, and/or a pyramid-type blending effect.

24. The apparatus of claim 18, wherein the processor is further configured to encode the video data including the modified background region, wherein the encoding occurs after modification the background region.

25. A system comprising:
an imaging device configured to capture video data; and
a computing system, wherein the computing system is communicatively coupled to the imaging device, and wherein the computing system is configured to:
detect a face based at least in part on the video data;
determine a region of interest and a background region based at least in part on the detected face; and
modify the background region to have a reduced image quality.

26. The system of claim 24, wherein the computing system is further configured to capture the video data in real-time.

27. The system of claim 24, wherein the detection of the face comprises detection of two or more faces.

28. The system of claim 24, wherein the reduction of the image quality associated with the background region comprises application of a blurring effect to the background region.

29. The system of claim 24, wherein the reduction of the image quality associated with the background region comprises application of a blurring effect to the background region based at least in part on a Point Spread Function and noise model.

30. The system of claim 24, wherein the computing system is further configured to apply a blending effect to a transition area, wherein the transition area is located at a border between the region of interest and the background region, and wherein the blending effect comprises an alpha-type blending effect, a feathering-type blending effect, and/or a pyramid-type blending effect.
